(19) United States
(12) Patent Application Publication
(10) Pub. No.: US 2008/0201639 A1
(43) Pub. Date: Aug. 21, 2008

(54) Apparatus and method for prompting a sequence of timed activities

(76) Inventor: Jay Shoman, Broomall, PA (US)

Correspondence Address: ROBERT J. YARBROUGH, ATTORNEY AT LAW, 201 NORTH JACKSON STREET, MEDIA, PA, 19063, US

(21) Appl. No.: 11/706,718

(22) Filed: Feb. 15, 2007

(51) Int. Cl. G06F 3/00; G06F 3/16

(52) U.S. Cl. 715/716; 715/727

(57) ABSTRACT

The Invention is an apparatus and method for prompting a sequence of timed activities such as a program of exercise. A computer is programmed to allow a user to select an activity or a plurality of activities and the duration of each selected activity. The computer is programmed to select a first prompt and a second prompt. A sequence of activities may be selected by the user and incorporated into a composite audio file, each with its own first and second prompts. The composite audio file may include music selected by the user. The first and second prompts may instruct the user to begin and end the activity while the music provides pacing cues to allow the user to pace him or herself during the period of the activity between the first and second prompts.

### I. BACKGROUND OF THE INVENTION

A. Field of the Invention

The Invention is a computer-enabled apparatus and method for providing activity and pacing prompts to a person to assist the person in performing activities according to a schedule determined by the person and at a pace determined by the person. The Invention is particularly useful for timed physical training, such as interval training, where a person performs an exercise regimen specified by the person in a specified sequence and at specified pace interspersed with rest periods of a specified duration. Music or other audio of the person's choosing provides pacing cues to the person.

B. Description of the Related Art

A balanced fitness program may involve many different exercises that are most effective if performed in a specific sequence, for a specific duration and at a specified intensity. A human trainer can provide verbal cues to assist a person in effectively pursuing such a program, such as cues to begin an exercise, end the exercise, initiate a rest period or conclude the rest period. The human trainer also can provide verbal cues during each exercise to allow the person to pace him or herself during the exercise. A fitness program may differ from one day to the next due to the need to rest specific muscle groups worked on prior days. The verbal cues provided by the human trainer therefore vary from one day to the next.

Personal MP3 players such as the IPod® are ubiquitous and allow a person to hear music or other audio information of the person's choosing at any convenient time and place. A person may use the combination of personal MP3 players and earphones to play music while performing an exercise. The periodic nature of the rhythm and tempo of the music assist a person in pacing his or her efforts, and hence assist the person in controlling the intensity of the exercise. Personal MP3 players playing prerecorded music selected by the person do not provide the audio cues that are provided by a human trainer.

Pre-recorded media such as audio tapes, video tapes and DVDs are known in the art for use while performing an exercise. Such pre-recorded media provide the person only with the cues specified by the maker of the pre-recorded media to perform only the exercises specified by the maker of the pre-recorded media. Such pre-recorded media may be accompanied by music or other audio as selected by the maker of the pre-recorded media. The pre-recorded media do not allow the person to determine his or her own exercise regimen separate and apart from the schedule selected by the maker of the pre-recorded media. The pre-recorded media also do not allow the person to select music or other audio to pace him or herself, apart from the selection made by the maker of the pre-recorded media.

The prior art does not teach the apparatus and method of the Invention.

### II. SUMMARY OF THE INVENTION

The Invention is a computer-enabled apparatus and method. The apparatus and method of the Invention allow a person to create a sequence of timed activities and to create a composite audio file to accompany the performance of the sequence of timed activities. The composite audio file includes audio cues for each timed activity in the sequence and includes audio information having rhythm and tempo to assist in pacing during performance of each timed activity.

A primary application of the Invention is the creation of a composite audio file to accompany a timed exercise program. The composite audio file is played to the user by a portable audio player. The composite audio file provides audio cues in the form of verbal prompts similar to those of a human trainer to begin and end exercises while the audio information having rhythm and tempo provides pacing cues to the user.

An “audio cue” may be any predetermined signal identifying an activity or providing notice to a person to begin or end the activity. For example, the “audio cue” may be recorded or synthesized speech in the form of a verbal prompt. As a second example, the “audio cue” may be one or more clicks or tones of a predetermined number, frequency, duration, pitch or loudness. As a third example, the “audio cue” may be an identifiable sound, such as a bell. The person may select audio cues to match a desired activity or may create new audio cues to correspond to any desired activity.

The audio cue may prompt the user to begin each activity in the sequence of timed activities. The audio cue may be a “first prompt” cuing the user to begin an activity or a “second prompt” cuing the user to end the activity. Where the sequence of timed activities includes more than one activity, the first and second prompts for the second or subsequent activities may be one and the same, as where a prompt cues the user to end one activity and begin another. The audio cue may dispense with the second prompt, since an audio cue to begin an activity necessarily provides notice to the user to end the previous activity.

The “audio information having rhythm and tempo” may be music in the form of one or more music computer files stored in any file format, such as WAV, MP3 (or other MP series files), WMA, MIDI or other file format. The sequence of timed activities may have a greater duration than a musical selection contained in a single music file. As a result, a person may select two or more music files from a music library stored on a computer or retrieved from CDs or other removable media. The person may elect to concatenate the series of music files into a “play list audio file.” The person may select music files to match the desired activity or may select any music or other audio information having rhythm and tempo that the person wishes.

The audio cues and the play list audio file are combined into the “composite audio file.” The composite audio file including both the play list audio file and the audio cues may be loaded into a portable audio player, such as an IPod®. A person may listen to the composite audio file while the person engages in the sequence of timed activities. The person will hear the audio cues advising the person as to the identity of the activity that the person is to perform and notifying the person of the beginning and end of the activity. During each activity in the sequence, the person hears the rhythm and tempo of the music, which allows the person to regulate his or her pace and hence the intensity of the timed activity.

The term “computer” means any microprocessor-controlled device that is capable of storing an audio file, that is capable of receiving and implementing an instruction to create a timed audio cue, and that is capable of associating the audio file and the timed audio cue. The term “computer” includes without (imitation a personal computer, laptop computer, palmtop computer, personal digital assistant, cellular telephone, personal audio player, server computer and client computer. The term “audio file” refers to any information capable of being stored in or generated by a computer and capable of being played by a portable audio player. The term “audio file” includes as least .WAV, MP3 (or other MP series files), .WMA, MIDI and similar files.

In the apparatus of the Invention, a computer is programmed to selectably display to a person a schedule corresponding to a sequence of activity. The person may select a template of the schedule stored in computer memory, may select a previously created schedule of activity, and may select a blank schedule of activities. Where the person selects a blank schedule of activities or selects a template, the person enters audio cues in a sequence, as by selecting verbal prompts from a menu of pre-recorded verbal prompts. The person may record or otherwise create his or her own verbal prompts and hence is not limited to pre-recorded audio cues. Where the person selects a previously created schedule of activity, the person may modify the previous schedule to meet the current requirements of the person.

As an example of creating an exercise schedule, the person might wish for a timed initial warm up period prior to the beginning of hard exercise. The person would select a first cue of “warm up” from a menu and the computer would enter “warm up” as the first item on the schedule. The person also would select a duration of the “warm up” item, for example, 5:00 minutes. As the first exercise in the schedule, the person may choose, for example, wide grip chin ups. The person will select the duration of the exercise. The person will then select further exercises and the number of repetitions and duration of each exercise. The person may choose to include rest periods between exercises and specify the duration of the rest periods. For exercises having repetitions, such as the wide grip chin ups, the person may specify the number of repetitions for each exercise.

After the person has selected the identity and duration of the warm up, exercises and rest periods and the number of repetitions for each exercise having repetitions, the person may select audio to accompany the exercise program. The person may choose one or more audio files, for example MP3 music files, appearing in the memory of the computer. Alternatively, the person may select music or other audio information having rhythm and tempo from removable storage media readable by the computer, such as CDs or DVDs. The selection by the person of music having rhythm and a tempo both entertains the person during each timed activity and allows the person to pace him or herself while performing each exercise.

The verbal cues and the music to be played between the cues are saved as a composite audio file such as an MP3 file and may be downloaded to a portable audio player, such as an MP3 player. The user may play the MP3 file over the portable MP3 player and hear the music and the verbal cues as selected by the user. The user then may engage in each of the timed activities as instructed in the audio cues while listening to the music selected by the person.

### III. BRIEF DESCRIPTION OF THE FIGURES

FIG. 1 is a schematic diagram of the apparatus of the Invention.

FIG. 2 is a flow chart of the operation of the Invention.

FIG. 3 is a continuation of FIG. 2.

FIG. 4 is a flow chart of the creation of a new activity by the user.

FIG. 5 is a flow chart of creation of the composite audio file.

FIG. 6 is a first screen shot showing the activity log.

FIG. 7 is a second screen shot showing the activity log.

FIG. 8 is a third screen shot showing the activity log.

### IV. DESCRIPTION OF AN EMBODIMENT

The Invention is a computer-enabled apparatus and method for providing audio cues to a user while the user is performing a timed sequence of activities. As noted above, a primary application of the Invention is creation of timed exercise programs such as for interval fitness training.

The user may select whatever activities the user wishes in whatever order the user wishes from menus of activities and thereby select audio cues for those activities. The user also may create new or additional activities and record any audio cue that the user wishes for the activity. The user will select the duration of each activity. The computer will create a sequence of audio cues including a first prompt for each selected activity in the order selected, the first prompt preferably being a verbal instruction to begin the activity. The sequence of audio cues may include a second prompt for each activity comprising a verbal instruction to end the activity. When the user triggers the sequence of audio cues, the first and second prompts are separated in time by the selected duration of each activity.

The sequence of audio cues may dispense with second prompts to signal the end of the activities in the sequence. In that event, when the user triggers the sequence of audio cues, the audio cue to begin an activity is separated by a time equal to the selected duration of the activity from the audio cue to begin a succeeding activity.

The user may select music or other audio information to play between the first and second prompts. The music or other audio information includes timing information; namely, rhythm and tempo. Playing the music or other audio information having rhythm and tempo between the first and second prompts of each activity assists the user in pacing him or herself while performing the activity. The music or other audio information also serves to entertain the user.

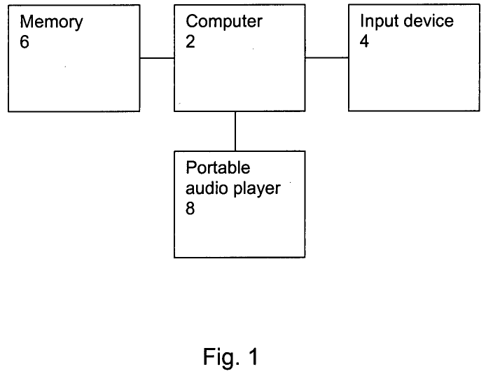

FIG. 1 is a schematic diagram showing the apparatus of the Invention. A computer 2 is operably connected to an input device 4 and computer memory 6. A user may use input device 4 to provide instructions to computer 2. Computer may store information in memory 6. Computer may create MP3 or other audio files 10 and store the files in memory 4. The MP3 or other audio files 10 may be downloaded to a portable audio player 8 as is known in the art.

The Invention is implemented by a computer program resident in memory 6 of computer 2. To gain access to the computer program implementing the Invention, the user will utilize computer 2 to access the Internet. The user will navigate to a web site from which the program may be downloaded. The user will download and install the program on computer 2 using conventional techniques. The user may be provided with a trial period for use of the program and may continue to use the program after the trial period by registering and paying for the program, all using conventional techniques.

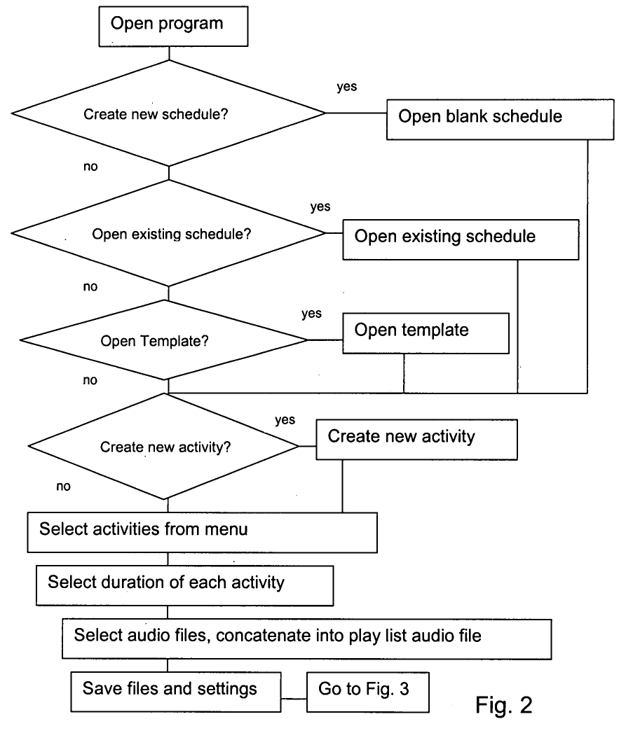

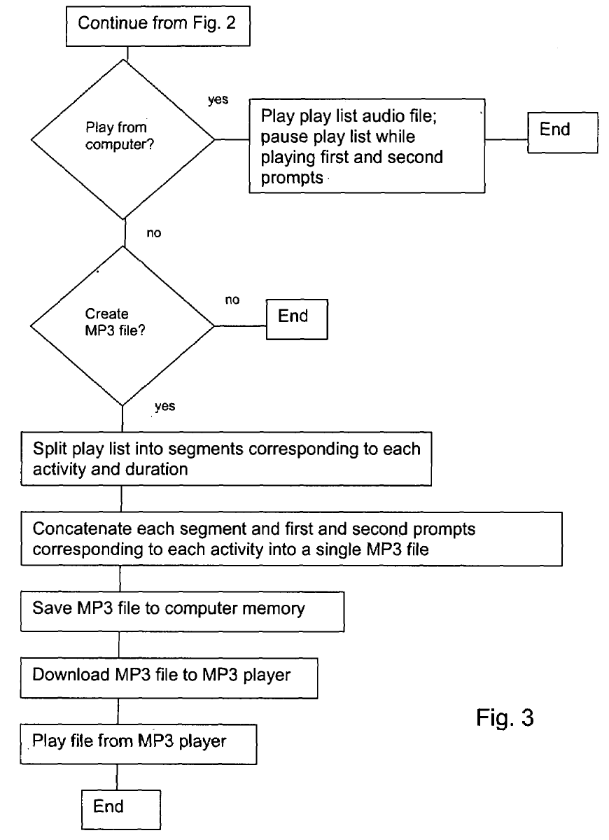

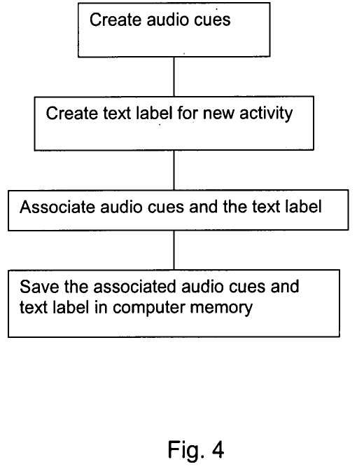

FIGS. 2 and 3 together form a single flow chart of the operation of the Invention. From FIG. 2, upon opening the program using computer 2, the user is presented with an ‘activity log’ 12 as shown by the screen shots of FIGS. 4, 5 and 6. The user first must create a schedule of activities 14 using the activity log 12. The user can elect to start with a blank activity log 16 and create an entirely new schedule of activities. The user can elect to open an existing schedule of activities 14 to either play the existing schedule 14 or to modify the existing schedule 14. The user can also open a prepared template for a schedule of activities 14. The user will create the new schedule of activities 14, modify the existing schedule 14 or complete the template schedule by selecting individual activities 16 from a menu.

If the user wishes to create a schedule of activities 14 that includes an activity 16 that is not included in the menu, the user can create his or her own new activity 16, as shown by FIG. 2 and illustrated in more detail in FIG. 4. The user may create a new activity 16 by creating audio cues for the activity 16, as by recording the first audio prompt. The first prompt may be a verbal instruction to begin the activity 16. The computer optionally may be configured to allow the user to create a second audio prompt for the activity. The second prompt may be a verbal instruction to end the activity 16. The audio cues may be machine generated, as with synthesized speech or a MIDI signal created by an internal or external synthesizer. Audio cues for activities 16 also may be downloaded from the Internet or other computer network.

The user will create a text label for the activity 16, as indicated by FIG. 4. From FIG. 4, the computer 2 will associate the text label with the audio cues. The computer 2 will save to computer memory 6 the associated text label and audio cues.

From FIG. 2, the user selects desired timed activities 16 from a menu. The selected activities 16 may include preexisting activities 16 or new activities 16 created by the user as described above with respect to FIG. 4. The user also will select the duration for each of the selected exercises or other activities 16.

As shown by FIGS. 2, the user creates a play list of music to accompany the workout. The user selects one or more audio files stored in computer memory 6 as the user's play list. The computer 2 associates the selected audio files in the play list with the activities 16 listed in the activity log 12. The user saves the files and settings, as shown by FIG. 2. The schedule of activities 14 is now complete and ready to play on computer 2.

FIG. 3 is a continuation of the flow chart of FIG. 2. FIG. 3 illustrates the playing of the schedule of activities 14. As shown by FIG. 3, the user may play the schedule of activities 14 directly from the computer 2. If the user elects to play the schedule 14 from the computer 2, the computer 2 plays the play list audio file from computer memory 6. At a predetermined time, the computer 2 pauses the play of the play list audio file and plays the first prompt for the first activity 16 on the activity list 14. The first prompt will instruct the user to begin the first activity 16. After the passage of a period of time corresponding to the selected duration of the activity 16, the computer 2 again pauses the play of the play list audio file. The computer then plays the first prompt of the next activity in the sequence of activities, thereby instructing the user to cease the previous activity in the sequence and begin the next activity in the sequence. Alternatively, the computer may interpose a second prompt between the pause of play of the play list audio file and the playing of the first prompt of the succeeding activity. The second prompt instructs the user to stop the activity 16. The computer 2 repeats the above process until the final activity 16 of the schedule of activities 14 is completed.

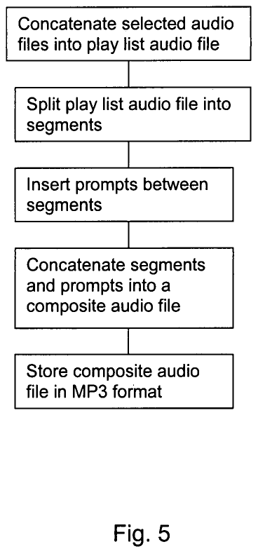

From FIG. 3 and as shown in more detail in FIG. 5, the user may save the schedule of activities 14 and associated music files as an MP3 or other audio file for play on a portable audio player 8. This feature is particularly useful where the user wishes to exercise away from the computer 2. As shown by FIGS. 3 and 5, if the user elects to create an MP3 file of the schedule 14 and audio files, the computer 2 will concatenate each of the selected music files into a single play list audio file. The computer 2 then will split the play list audio file into sequential timed segments. Each sequential timed segment will correspond to a one of the selected timed activities 16. The duration of each segment will be equal to the selected duration of the timed activity 16 to which the segment corresponds.

The computer 2 will insert the first prompt for a timed activity 16 at the beginning of the segment to which the timed activity 16 corresponds. If a second prompt is associated with the timed activity 16, the computer 2 will insert the second prompt for the timed activity 16 at the end of the segment to which the timed activity 16 corresponds. If a second prompt is not associated with the timed activity 16, the computer will insert the first prompt for the next timed activity 16 in the sequence 14.

The computer 2 then will concatenate the segments of the play list audio file and each first and second prompt and each other audio cue for each of the timed activities 16 in the activities schedule 14 into a single MP3 file. The single MP3 file including both the play List audio file and each first and second prompt is the “composite audio file.”

The user may save the composite audio file to computer memory 6 and download the composite audio file to a portable audio player 8, such as an MP3 player. The user can play the composite audio file from the portable audio player 8. When the user plays the composite audio file from the portable audio player 8, the user hears the first prompt of the first activity, followed by the first segment of music from the play list, followed by the first prompt of the next activity 16 in the sequence 14. Where a second prompt is associated with an activity 16, the user will hear the second prompt instructing the user to end the activity 16 prior to hearing the first prompt for the succeeding activity 16. The foregoing sequence is repeated until the end of the final selected activity is reached. The user then wilt hear a message that the program is concluded.

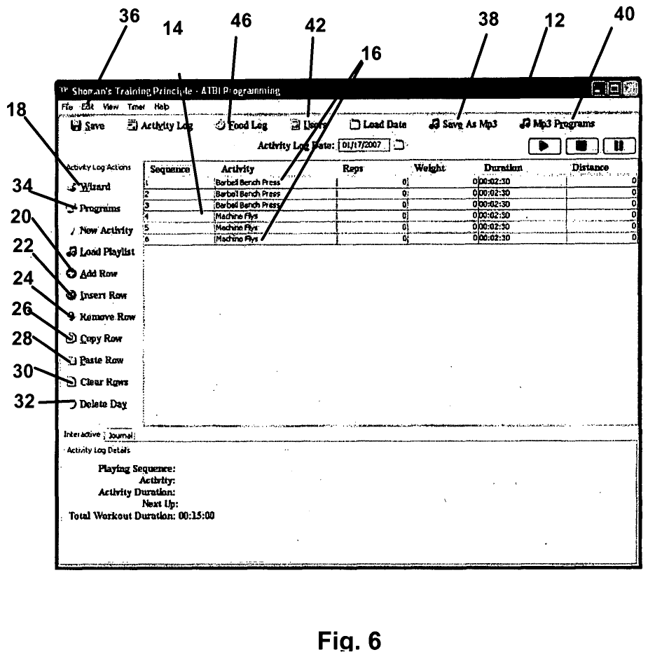

FIG. 6 shows the application of the steps shown by FIGS. 2 and 3 to a particular program of timed exercise. FIG. 6 is a screen shot of the ‘activity tog’ 12 presented to the user by computer 2. From FIG. 6, and as an example of creating a schedule of activities in the activity tog 12, the user plans a chest workout that will include three sets of bench presses and three sets of machine flys. In the activity tog 12, the user selects ‘wizard’ 18, which presents the menu of activities 16 to the user. The menu may contain many activities 16 of many different categories. The menu may be filtered by category to ease navigation through the menu. The user selects each of the desired exercises from the wizard 18 and each activity 16 is entered into the ‘activity log’ 12 as shown by FIG. 6. The user selects the duration for each exercise and how many sets of each exercise the user will perform. For the exercises shown by FIG. 6, the user enters three sets for each exercise and 00:2:30, corresponding to two and a half minutes, for the duration of each exercise. Selection of the activities and duration of each activity by the user shown by FIG. 6 automatically instructs the computer program to select audio cues for each selected activity. The audio cues will include a first prompt to begin the activity 16 and may include a second prompt to end the activity 16.

The user may edit the table of activities 14 using buttons shown by FIG. 6. For example, the user may select the “add row” button 20 to add a row to the table. The user may select the “insert row” button 22 to insert a row at a selected location in the table. The user may select the “remove row” 24 to remove a row from the table. The user may select the “copy row” 26 button to copy a row from the table and may select the “paste row” 28 to insert the copied row at a selected location in the table. Selecting the “clear rows” 30 clears all contents of the activity log 12, while selecting the “delete day” deletes all contents from the activity log 12 for a particular date. Upon completion of the schedule of activities 14 including selection of all of the activities 16 and durations desired by the user, the user selects the “programs” button 34 shown by FIG. 6. The computer 2 then will store the selected activities and durations in computer memory 2, ready for play by the computer 2 to the user.

The user can elect whether include music to accompany his or her workout. If the user elects to have musical accompaniment, the user must create a play list. From FIG. 6, the user selects the ‘edit’ button 36, which allows the user to select audio files from computer memory to form the user's play list. The computer 2 then associates the selected play list audio files with the audio cues for the selected activities 16 in the schedule of activities 14.

The schedule of timed exercise created by the user is now ready to play. The user may initiate the exercise program from the computer 2. The computer 2 then plays the first audio file in the play list and at a predetermined time pauses the audio file. During the pause, the computer plays the first prompt for the first activity 16. The first prompt for the first activity 16 shown by FIG. 6 will instruct the user to begin the barbell bench press. The computer then resumes play of the audio file in the play list for the duration of the first activity 16. As shown by FIG. 6, the duration of the first barbell bench press as specified by the user is 00:02:30 minutes. Two and one half minutes after the first prompt, the computer 2 again pauses the play of the audio files in the play list. If a second prompt is associated with the first activity 16, the computer then plays the second prompt, which instructs the user to end the first activity 16. At the conclusion of the first audio file of the user's play list, the computer 2 plays the second audio file in the play list. The computer 2 therefore plays the audio files in the play list sequentially, pausing play of those audio files to play the audio cues at time intervals specified by the user. The computer 2 moves stepwise through the list of activities until the last activity is completed. The user may pause or stop playback.

As shown by FIGS. 2, 5 and 6 the user may elect to create an MP3 or other audio file for play of the exercise program on a portable audio player 8 when the user is away from computer 2. To create an MP3 file of the exercise program created as described in the previous paragraphs, the user will select the “Save as MP3 ” button 38 from the toolbar, shown by FIGS. 5 and 6. The computer 2 then will execute the steps illustrated by FIG. 5. The computer 2 will concatenate the selected music files in sequence into a single play list audio file. The computer wilt split the play list audio file into segments, with the duration of each segment being defined by the selected duration of each selected activity 16. The computer 2 wilt concatenate the segments and the audio cues for each selected activity 16 into a composite audio file and save the composite audio file to computer memory 6. The saved composite audio file preferably is in MP3 format and is available for download to a portable MP3 player 8 or other audio device. The composite audio file also is available for upload to the Internet or may be attached to an email for transmission. The composite audio file also may be played by computer 2, provided computer 2 is programmed with a compatible audio player.

To load the composite file to a portable audio player 8, the user will select the “MP3 Programs” button 40 shown by FIG. 6. Upon selection of the MP3 Programs button 40, the user is presented with a popup menu of all saved composite audio files. The user selects one of the saved composite audio files from the popup menu and selects a destination to which to send the file. The user selects the portable audio player 8 as the destination and the computer 2 loads the selected composite audio file onto the portable audio player 8. The composite audio file now is ready to be played using the portable audio player 8 at a location away from computer 2.

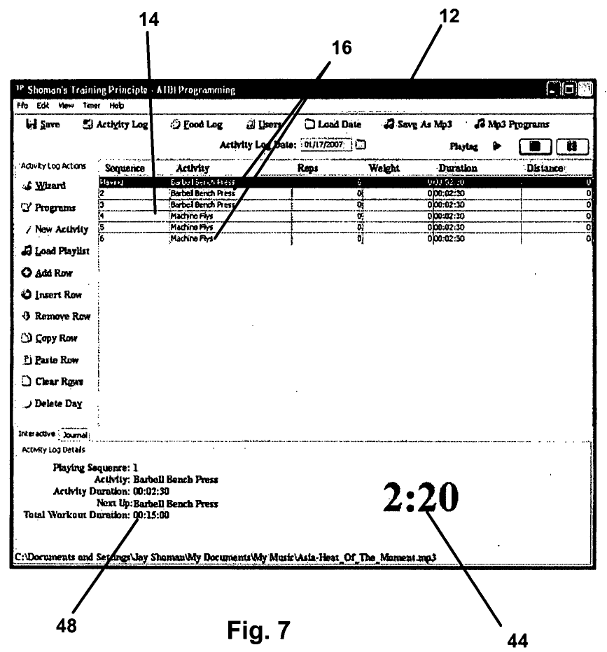

The user may utilize other features of the Invention shown by FIG. 6. For example, selection of the “users” button 42 allows timed exercise programs for multiple users to be entered. This feature may be particularly useful for coaches, who may individually tailor timed exercise routines for multiple persons, such as the members of a sports team. Other features include a timer in the form of a numerical display 44 (shown by FIG. 7) or a visual display of a stopwatch to provide a visual cue of the progress of the exercise program when the program is played on the computer 2. The “food log” button 46 allows the user to track food intake, as is known in the art.

FIGS. 7 is a screen shot of the activity log 12 during playback. The timer 44 is displayed, -as is a status display 48 of the activity 16 being performed and the next activity 16 to be performed.

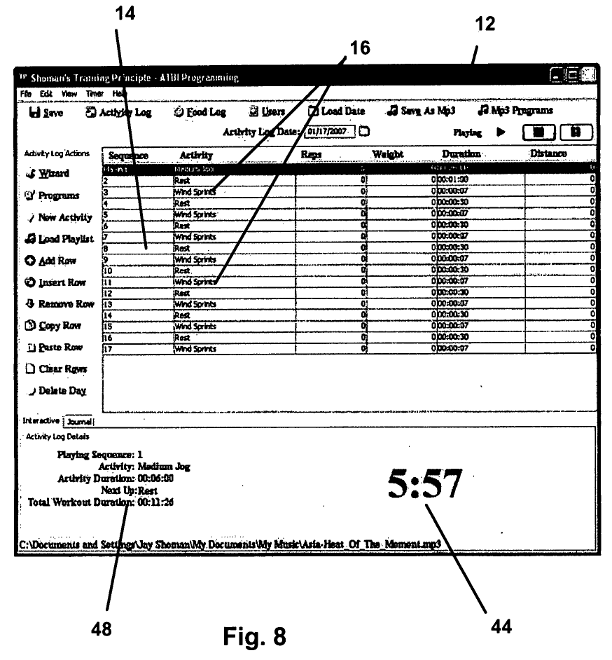

FIG. 8 is a screen shot of the activity log 12 where the selected program is a sequence of wind sprints. As indicated by FIG. 8, a selected activity 16 may be a rest period and the rest period may be interposed between other activities 16.

In describing the above embodiments of the invention, specific terminology is selected for the sake of clarity. However, the invention is not intended to be limited to the specific terms so selected, and it is to be understood that each specific term includes all technical equivalents that operate in a similar manner to accomplish a similar purpose.

I claim:

1. A method for prompting a sequence of timed activities, the method comprising:
a. presenting by a computer of a menu of the timed activities to a user;
b. selecting by said user using said computer of a timed activity from said menu;
c. selecting by said user using said computer of a duration for said selected timed activity;
d. selecting by said computer of an audio cue, said audio cue being determined by said selected timed activity;
e. selecting by said user of an audio information having a rhythm and a tempo, said audio information being stored in a computer memory operably associated with said computer;
f. associating by said computer of said audio cue and said audio information, said association of said audio cue and said audio information being a timed association, said timed association being determined by said selected duration of said selected timed activity.

2. The method of claim 1 wherein,
a. said step of selecting by-said user of the timed activity comprises: selecting by said user of a plurality of the timed activities from said menu, said user arranging in an order each of said plurality of the timed activities, said arrangement of said order of said plurality of the timed activities defining the sequence of the timed activities;
b. said step of selecting said duration for said timed activity further comprises: selecting said duration for each of said plurality of the timed activities in the sequence;
c. said step of selecting by said computer of said audio cue comprises: said audio cue being a one of a plurality of said audio cues, said computer selecting a one of said plurality of said audio cues for each of said plurality of the timed activities in the sequence;
d. said step of associating by said computer of said audio cue and said audio information further comprises: associating by said computer of said audio information and said selected one of said plurality of said audio cues for each of said plurality of the timed activities in the sequence, said association of said audio information and said one of said plurality of said audio cues for each of said plurality of the timed activities being said timed association, said timed association being determined by said selected duration of each of said selected plurality of the timed activities.

3. The method of claim 2 wherein each of said plurality of said audio cues is a one of a plurality of first prompts, the method further comprising:
a. playing said one of said plurality of said first prompts associated with a first of said plurality of the timed activities in the sequence;
b. playing said audio information;
c. pausing said play of said audio information, said pausing of said play of said audio information occurring at a first predetermined time with respect to said playing of said one of said plurality of said first prompts associated with said first of said plurality of the timed activities, said first predetermined time being determined by said selected duration of said first timed activity in the sequence;
d. playing said one of said plurality of said first prompts associated with a second of said plurality of the timed activities in the sequence;
e. playing said audio information;
f. pausing said play of said audio information, said pausing of said play of said audio information occurring at a second predetermined time with respect to said playing of said one of said plurality of said first prompt associated with said second of said plurality of the timed activities, said second predetermined time being determined by said selected duration of said second timed activity in the sequence.

4. The method of claim 2 wherein said step of selecting by said user of said audio information comprises: selecting by said user of a plurality of music audio files.

5. The method of claim 4, the method further comprising: concatenating said plurality of music audio files into a play list audio file.

6. The method of claim 5 wherein said plurality of audio cues comprises a plurality of first prompts, each of said plurality of first prompts corresponding to a one of said plurality of the timed activities, said step of associating by said computer of said audio information and said audio cue for each of said plurality of the timed activities in the sequence further comprises:
a. cutting said play list audio file into a plurality of segments, each of said plurality of segments corresponding to a one of said plurality of the timed activities, each of said plurality of said segments having a length, said length of each of said plurality of segments being determined by said duration of said one of said plurality of the timed activities corresponding to said segment;
b. inserting by said computer of each of said plurality of said first prompts corresponding to each of said plurality of the timed activities before each of said plurality of segments corresponding to each of said plurality of the timed activities, said plurality of segments and said inserted plurality of said first prompts defining a composite audio file;
c. concatenating by said computer of said composite audio file and saving said composite audio file in a form downloadable by a portable audio player.

7. The method of claim 6 wherein each of said plurality of said first prompts is a one of a plurality of first verbal instructions.

8. The method of claim 7 wherein said one of said plurality of first verbal instructions is a direction to begin a fitness-related activity.

9. An apparatus for prompting a sequence of timed activities, the apparatus comprising:
a. a computer; and
b. a computer memory operably associated with said computer, said computer being programmed to allow a user to select a plurality of activities from a menu of activities, said computer being programmed to allow said user to select the sequence of said selected plurality of activities, said computer being programmed to allow said user to select a duration of each said selected activity of said plurality of activities, said computer being programmed to select a plurality of first prompts, each of said plurality of first prompts corresponding to a one of said plurality of activities, each said first prompt being defined by said one of said plurality of selected activities to which said first prompt corresponds, said computer being programmed to allow said user to select from said computer memory an audio information having a rhythm and a tempo, and said computer being programmed to associate each of said plurality of first prompts in a timed and sequential association with said audio information having rhythm and tempo, whereby each said first prompt may be played to said user in sequence and said audio information having said rhythm and said tempo may provide a pacing cue to said user.

10. The apparatus of claim 9 wherein said audio information having a rhythm and a tempo is a music.

11. The apparatus of claim 10 wherein said music comprises: a plurality of music files, each of said plurality of music files being selected by said user, said computer being programmed to concatenate said plurality of said music files into a play list audio file.

12. The apparatus of claim 10 wherein each of said plurality of said first prompts cues said user to begin said selected activity to which said first prompt corresponds.

13. The apparatus of claim 12 wherein said programming of said computer to associate said plurality of said first prompts in said timed and sequential association with said audio information comprises: said computer being programmed to associate said plurality of said first prompts to play back in the sequence with a period of time interposed between each said first prompt and each succeeding said first prompt in the sequence, said period of time being defined by said selected duration of said selected activity to which each of said plurality of first prompts corresponds, said computer being programmed to play back said play list during said period of time interposed between said plurality of first prompts in the sequence.

14. The apparatus of claim 12 wherein said menu of activities consists of a menu of exercise-related activities.

15. The apparatus of claim 14 wherein said computer is programmed to cut said play list audio file into a plurality of segments, each segment having a length, each said length corresponding to said period of time interposed between each said first prompt and each succeeding said first prompt in the sequence.

16. The apparatus of claim 15 wherein said computer is programmed to interpose a one of said plurality of segments between each said first prompt and each succeeding said first prompt in the sequence, said computer being further programmed to concatenate said plurality of interposed segments and each said first prompt into a composite audio file.

17. The apparatus of claim 16 wherein said first prompt is are selected from a list consisting of pre-recorded prompts, prompts recorded by said user and prompts selected by said user.

18. An apparatus for prompting a sequence of timed activities, the apparatus comprising: a computer, said computer being programmed to allow a user to select an activity and a duration of said activity, said computer being programmed to select a first prompt occurring at a first time, said selected duration of said activity defining said first time, said computer being programmed to allow said user to select a music file, said music file containing music having rhythm and tempo, said computer being programmed to associate said first prompt with said music file, whereby said first prompt may be played at said first time and said music file played during said duration of said activity, whereby and said user may pace him or herself during performance of the timed activity based on said rhythm and said tempo of said music.

19. The apparatus of claim 18, the apparatus further comprising: a computer memory operably associated with said computer, said music file comprising a plurality of said music files, each of said plurality of music files being selected by said user from said computer memory, said computer being programmed to concatenate said plurality of said music files into a play list audio file, said computer being configured to cut said play list audio files into a segment having said duration, said computer being configured to insert said segment after said first prompt, said computer being configured to concatenate said first prompt, and said segment into a composite audio file, said computer being programmed to store said composite audio file in said computer memory in a form that may be downloaded by a portable audio player, whereby said user may listen to said first and said second prompts on said portable audio player and may listen to said first prompt followed by said play list audio file.

20. The apparatus of claim 19 wherein said computer is programmed to allow said user to select a plurality of said activities as the sequence of the timed activities, each of said selected plurality of activities having a one of a plurality of said first prompts associated with said activity, said computer being programmed to allow said user to select a one of a plurality of said durations for each of said selected plurality of activities, said composite audio file including said first for said each of said selected plurality of activities in the sequence, whereby when said composite audio file is played, said user may hear said first prompt associated with each of said selected plurality of activities in sequence with said selected duration between each said first prompt in the sequence and said user may hear said music during said duration of said selected activity.
